(19) United States
(12) Patent Application Publication
(10) Pub. No.: US 2025/0150199 A1
(43) Pub. Date: May 8, 2025

(54) SACRIFICIAL MODE

(71) Applicant: CORNELIS NETWORKS, INC., WAYNE, PA (US)

(72) Inventor: Brent ROTHERMAL, Wayne, PA (US)

(73) Assignee: CORNELIS NETWORKS, INC., WAYNE, PA (US)

(21) Appl. No.: 18/503,137

(22) Filed: Nov. 6, 2023

(51) Int. Cl. H04L 1/00; H04L 1/1829; H04L 41/0631

(52) U.S. Cl. CPC H04L 1/0025; H04L 1/1848; H04L 41/0645

(57) ABSTRACT

A sacrificial mode of link operation during link negotiation and initialization is provided. Embodiments include transmitting (804), by a link manager (402) of a switch (102) in a high-performance computing system, a sacrificial mode parameter (808) for the local link manager (402), receiving (806), by the link manager (402), a sacrificial mode parameter (820) for a link partner, establishing (816), by the link manager (402), a local sacrificial period (818) in dependence upon the local sacrificial mode parameter (808) and the received sacrificial mode parameter (820) of the link partner; and operating (822) one or more ports in sacrificial mode for the sacrificial period (818) including suspending error correction during sacrificial mode.

### BACKGROUND

High-Performance Computing (HPC) refers to the practice of aggregating computing in a way that delivers much higher computing power than traditional computers and servers. In the context of HPC, network switches play a crucial role in facilitating communication between the various components of a cluster, such as servers, storage devices, and other networking equipment.

Link negotiation and initialization (LNI) are important processes that occur when connecting devices to these switches to establish and configure network connections. During link negotiation, devices exchange information about their capabilities, such as supported link speeds, lane widths, and so on. They then agree on a common configuration for the connection. Initialization of switches involves self-tests, hardware initialization, and loading of the system firmware. Switch ports need to be activated and configured according to the network's requirements. For HPC clusters, this often involves setting up high-speed, low-latency connections between the compute nodes and ensuring proper network segmentation.

All link-based architectures have data mode transitions between different phases of link operation, such as the transition from a training pattern during LNI to mission mode operation when a link is operational and able to move network traffic, sometimes called ‘link up.’ Such a transition can be very stressful on the link and cause a momentary burst of errors to occur. This error burst can be caused by spectral differences between the training pattern signal and the mission mode signal. In architectures where errors cause a replay, this burst of errors can be sufficiently long to cause the link to go back into training mode, creating an endless loop. It would be advantageous to transition into mission mode without impediment from deleterious artifacts of this transition.

### BRIEF DESCRIPTION OF THE DRAWINGS

Many aspects of the present disclosure can be better understood with reference to the following drawings. The components in the drawings are not necessarily to scale, with emphasis instead being placed upon illustrating the principles of the disclosure. Moreover, in the drawings, like reference numerals designate corresponding parts throughout the several views.

FIG. 1 sets forth a system diagram of an example high-performance computing environment for sacrificial link operation according to embodiments of the present invention.

FIG. 2 sets forth a line drawing of a switch configured for sacrificial link operation according to example embodiments of the present invention.

FIG. 3 sets forth a block diagram of a compute node configured for sacrificial link operation according to embodiments of the present invention.

FIG. 4 sets forth a flowchart illustrating an example method for sacrificial link operation according to embodiments of the present invention.

### DETAILED DESCRIPTION

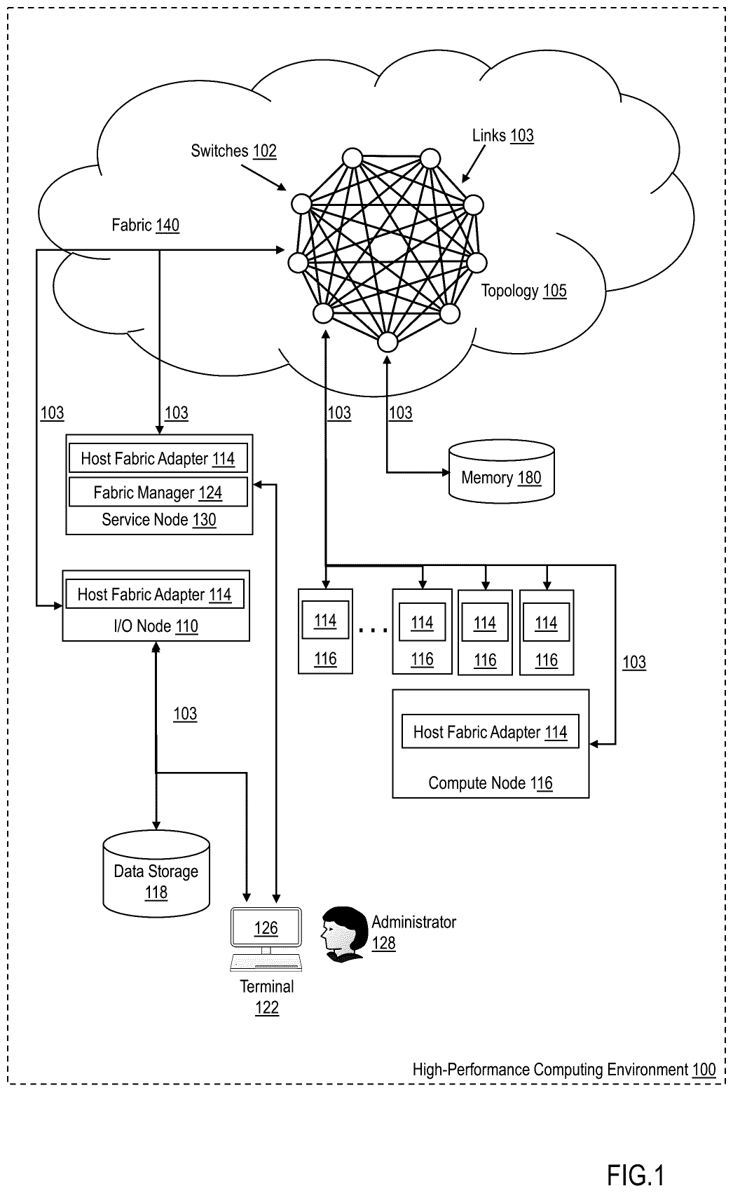

Methods, systems, and devices for sacrificial link operation during link negotiation and initialization according to embodiments of the present invention are described with reference to the attached drawings. FIG. 1 sets forth a system diagram of an example high-performance computing environment. The example high-performance computing environment of FIG. 1 includes a fabric (140) which includes an aggregation of switches (102), links (103), and host fabric adapters (HFAs) (114) integrating the fabric with the devices that it supports. The fabric (140) according to the example of FIG. 1 is a unified computing system that includes interconnected nodes and switches that often look like a weave or a fabric when seen collectively.

The switches (102) of FIG. 1 are multiport modules of automated computing machinery, hardware and firmware, which receive and transmit packets. Typical switches receive packets, inspect packet header information, and transmit the packets according to routing tables configured in the switch. Often switches are implemented as, or with, one or more application specific integrated circuits (‘ASICs’). In many cases, the hardware of the switch implements packet routing and firmware of the switch configures routing tables, performs management functions, fault recovery, and other complex control tasks as will occur to those of skill in the art.

The switches (102) of the fabric (140) of FIG. 1 are connected to other switches with links (103) to form one or more topologies. A topology is a wiring pattern among switches, HFAs, and other components and routing algorithms used by the switches to deliver packets to those components. Switches, HFAs, and their links may be connected in many ways to form many topologies, each designed to optimize performance for their purpose. Examples of topologies useful according to embodiments of the present invention include HyperX topologies, Star topologies, Dragonflies, Megaflies, Trees, Fat Trees, and many others.

Links (103) may be implemented as copper cables, fiber optic cables, and others as will occur to those of skill in the art. In some embodiments, the use of double density cables may also provide increased bandwidth in the fabric. Such double density cables may be implemented with optical cables, passive copper cables, active copper cables and others as will occur to those of skill in the art.

The example of FIG. 1 includes a service node (130). The service node (130) provides services common to pluralities of compute nodes, loading programs into the compute nodes, starting program execution on the compute nodes, retrieving results of program operations on the compute nodes, and so on. The service node communicates with administrators (128) through a service application interconnect that runs on computer terminal (122).

The service node (130) of FIG. 1 has installed upon it a fabric manager (124). The fabric manager (124) of FIG. 1 is a module of automated computing machinery for configuring, monitoring, managing, maintaining, troubleshooting, and otherwise administering elements of the fabric (140). The example fabric manager (124) is coupled for data communications with a fabric manager administration module with a user interface (126) allowing administrators (128) to configure and administer the fabric manager (124) through a terminal (122) and in so doing configure and administer the fabric (140). In some embodiments of the present invention, routing algorithms are controlled by the fabric manager (124) which in some cases configures routes from endpoint to endpoint.

The fabric manager (124) of FIG. 1 publishes configurations and policies for sacrificial link operation during link negotiation and initialization. Such policies may dictate whether a particular port may have some or all of its capabilities supported, enabled, activated, and so on including capabilities for sacrificial mode operation during LNI. Such policies and configurations may be used locally by switches and HFAs for sacrificial link operation during link negotiation and initialization according to embodiments of the present invention.

The example of FIG. 1 includes an I/O node (110) responsible for input and output to and from the high-performance computing environment. The I/O node (110) of FIG. 1 is coupled for data communications to data storage (118) and a terminal (122) providing information, resources, UI interaction and so on to an administrator (128).

The compute nodes (116) of FIG. 1 operate as individual computers including at least one central processing unit (‘CPU’), volatile working memory and non-volatile storage. The hardware architectures and specifications for the various compute nodes vary and all such architectures and specifications are well within the scope of the present invention as will occur to those of skill in the art. Such non-volatile storage may store one or more applications or programs for the compute node to execute.

Each compute node (116) in the example of FIG. 1 has installed upon it a host fabric adapter (114) (‘HFA’). An HFA is a hardware component that facilitates communication between a computer system and a network or storage fabric. It serves as an intermediary between the computer's internal bus architecture and the external network or storage infrastructure. The primary purpose of a host fabric adapter is to enable a computer to exchange data with other devices, such as servers, storage arrays, or networking equipment, over a specific communication protocol. HFAs deliver high bandwidth and increase cluster scalability and message rate while reducing latency.

Properly configured and managed switches and HFAs are essential for reducing bottlenecks and maximizing the computational capabilities of the HPC environment of FIG. 1. Link negotiation and initialization (LNI) includes link training prior to transitioning to mission mode. During the training phase, HPC systems and network components are initialized. This includes booting up the compute nodes, initializing network switches and routers, and configuring various network settings. Network switches often engage in topology discovery, where they identify the connections between devices and establish a map of the network topology. This information is critical for efficient data routing. Routing tables are configured to determine how data packets should be forwarded within the network. During the topology discovery phase, routes may be less dynamic and more focused on discovering optimal paths. Network administrators may monitor and profile network traffic during the topology discovery phase to understand the behavior and requirements of the applications that will run in mission mode.

In mission mode, the HPC system allocates computational resources, including CPU cores, memory, and storage, to specific tasks or jobs. These jobs can include scientific simulations, data analysis, or other compute-intensive workloads. The links (103) are used in mission mode to communicate data between a plurality of compute nodes (116) and in some cases I/O nodes (110), using the switches (102) to achieve connectivity.

To facilitate the transition between training in LNI and mission mode, the switches of FIG. 1 are configured for sacrificial link operation during link negotiation and initialization according to embodiments of the present invention. During link negotiation and initialization, the switches of FIG. 1 exchange configuration information with link partners including sacrificial mode parameters. The switches of FIG. 1 establish a local sacrificial period in dependence upon the parameters and operate one or more ports in sacrificial mode for the sacrificial period prior to entering mission mode.

A sacrificial period is an extension of the training period prior to mission mode. During the sacrificial period, the switch operates in a manner otherwise similar to mission mode but with error correction suspended. In sacrificial mode the switches may continue to identify and transmit errors; however, no correction is implemented during the sacrificial period. In this way, the switch is allowed a grace period from error correction prior to a full entry into mission mode

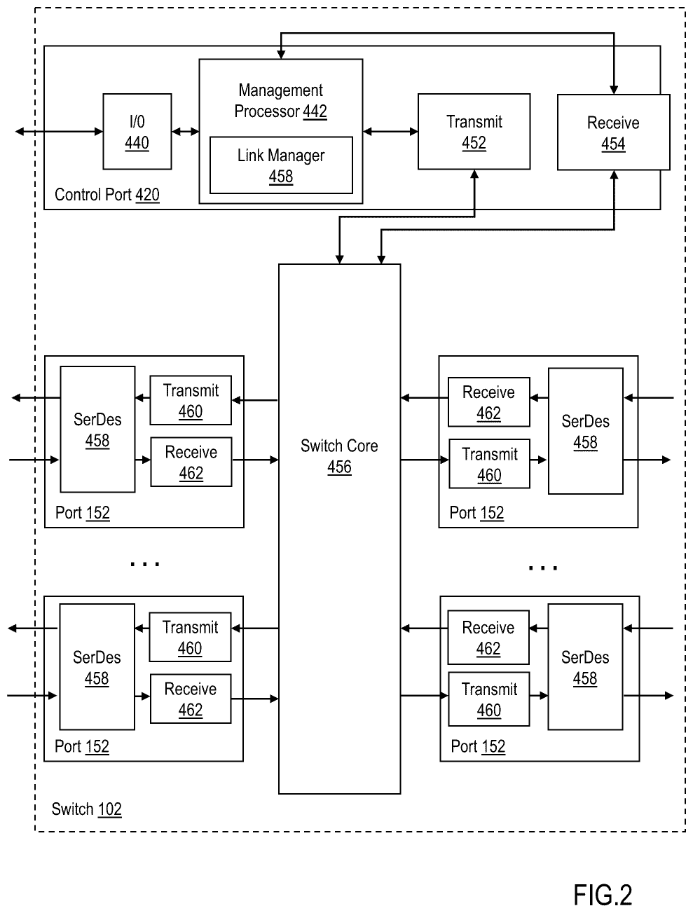

For further explanation, FIG. 2 sets forth a block diagram of an example switch capable of sacrificial link operation between LNI and mission mode according to embodiments of the present invention. The example switch (102) of FIG. 2 includes a control port (420), a switch core (456), and a number of ports (152). Each port (152) is coupled with the switch core (456) and a transmit controller (460) and a receive controller (462) and a SerDes (458).

The control port (420) of FIG. 2 includes an input/output (′I/O′) module (440), a management processor (442), a transmit controller (452), and a receive controller (454). The management processor (442) of the example switch of FIG. 2 maintains and updates routing tables for the switch. In the example of FIG. 2, each receive controller maintains the latest updated routing tables.

The management processor (442) includes a link manager (442). The link manager of FIG. 2 is configured for sacrificial link operation during link negotiation and initialization according to embodiments of the present invention. The link manager of FIG. 2 is configured to transmit a sacrificial mode parameter for one or more ports administered by the local link manager. Such a sacrificial mode parameter may be transmitted as part of the configuration information exchanged between link partners during LNI. The link manager of FIG. 2 is also configured to receive sacrificial mode parameters for each link partner and establish a local sacrificial period in dependence upon the local sacrificial mode parameter and the received sacrificial mode parameters for the link partner.

The link manager of FIG. 2 is configured to operate one or more ports in sacrificial mode for the sacrificial period including suspending error correction during sacrificial mode. In sacrificial mode, the receive controller (462) of FIG. 2 suspends error correction in response to received errors for the sacrificial period. In many cases, the suspended error correction is link-level replay. Suspending error correction may include preventing the link from going down or returning to training mode based on received errors. Furthermore, in some embodiments, errors may be observed but not corrected during the sacrificial period. Sacrificial mode allows a transition to mission mode without invoking unnecessary replays and undesired return to training mode. In some embodiments, the link manager can be integrated into the ASIC as a shared resource across multiple ports, per port, or external to the ASIC and communicating with the ports via the I/O (440)

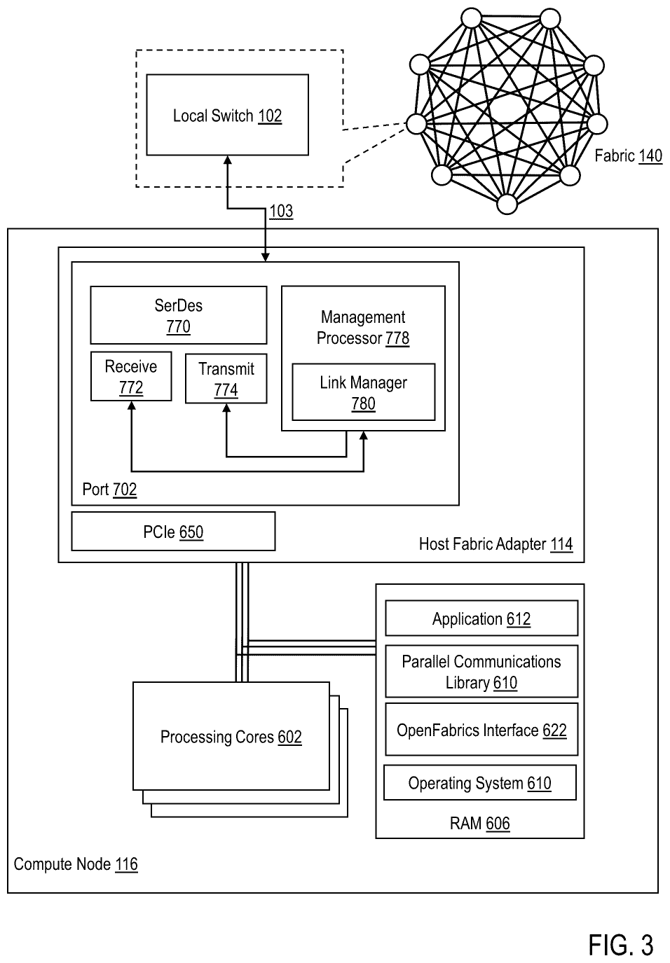

For further explanation, FIG. 3 sets forth a block diagram of a compute node including a host fabric adapter (114) according to embodiments of the present invention. The compute node (116) of FIG. 3 includes processing cores (602), random access memory (‘RAM’) (606) and a host fabric adapter (114). The example compute node (116) is coupled for data communications with a fabric (140) using a link (103) to the present invention.

Stored in RAM (606) in the example of FIG. 3 is an application (612), a parallel communications library (610), an OpenFabrics Interface module (622), and an operating system (608). Applications for high-performance computing environments, artificial intelligence, and other complex environments are often directed to computationally intense problems of science, engineering, business, and others. A parallel communications library (610) is a library specification for communication between various nodes and clusters of a high-performance computing environment. A common protocol for HPC computing is the Message Passing Interface (‘MPI’). MPI provides portability, scalability, and high-performance. MPI may be deployed on many distributed architectures, whether large or small, and each operation is often optimized for the specific hardware on which it runs.

OpenFabrics Interfaces (OFI), developed under the OpenFabrics Alliance, is a collection of libraries and applications used to export fabric services. The goal of OFI is to define interfaces that enable a tight semantic map between applications and underlying fabric services. The OFI module (622) of FIG. 3 packetizes the message stream from the parallel communications library for transmission.

The compute node of FIG. 3 includes a host fabric adapter (114). The HFA (114) of FIG. 3 includes a PCIe interconnect (650) or other such interconnect as will occur to those of skill in the art and a fabric port (702). The port (702) is coupled for data communications with a number of potential link partners (102). The HFA of FIG. 3 is configured for sacrificial link operation during link negotiation and initialization according to embodiments of the present invention.

The host fabric adapter (114) includes at least one fabric port (702) that includes a management processor (778), a serializer/deserializer (770); a receive controller (772) and a transmit controller (774). The management processor (778) includes a link manager (780) comprising logic configured to establish a sacrificial period in dependence upon a local sacrificial mode parameter and a received sacrificial mode parameter of a link partner and operate one or more ports in sacrificial mode for the sacrificial period including suspending error correction.

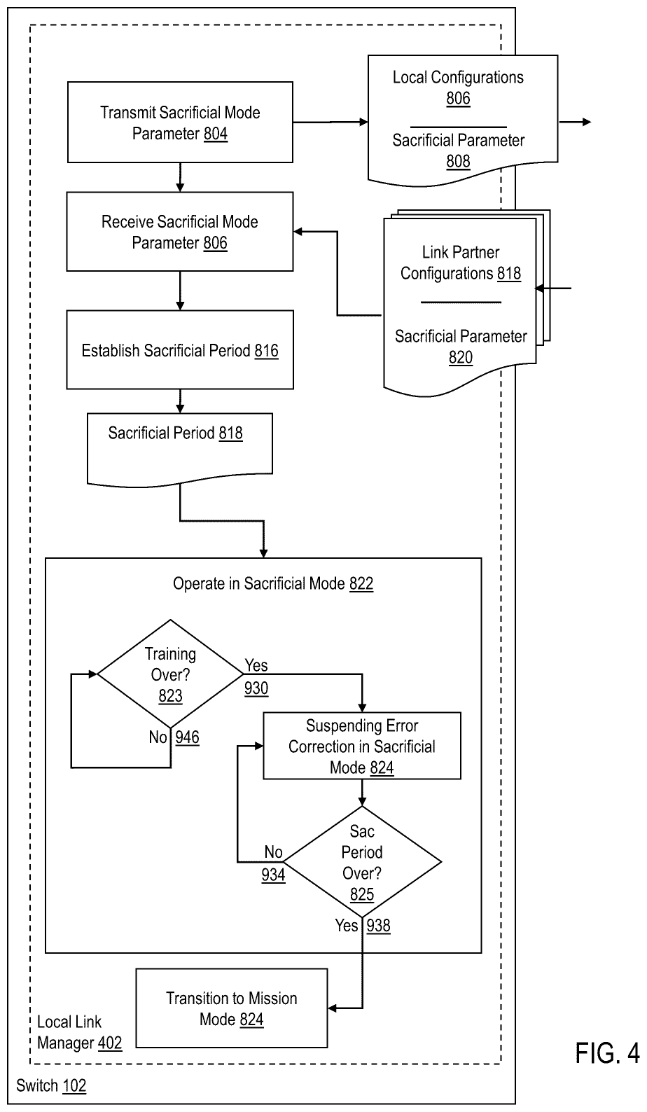

For further explanation, FIG. 4 sets forth a flow chart illustrating a method of sacrificial link operation during the transition between link negotiation and initialization and mission mode according to embodiments of the present invention. The method of FIG. 4 includes transmitting (804), by a link manager (402) of a switch (102) in a high-performance computing system, a sacrificial mode parameter (808) for one or more ports (152) administered by the local link manager (402) and receiving, by the link manager (402), a sacrificial mode parameter (820) for a link partner. In some embodiments, a sacrificial mode parameter may be a static timeout value. In alternate embodiments, the parameter may be a value used in a dynamic calculation of a sacrificial period using many factors such as the configurations and capabilities of the local switch and those of its one or more link partners.

A sacrificial period is a period of suspended error correction prior to mission mode. Suspending error correction during the sacrificial period may prevent the link from unnecessarily going down or returning to training mode based on errors. In a high-performance computing (HPC) system, link training is a crucial step to establish a reliable and high-speed connection between devices. Link training involves exchanging training sequences or patterns between the switches. The switch continuously monitors the status of the link during the training phase. It is not solely reliant on timing; rather, it looks for specific patterns or signals that indicate the successful completion of link training. These patterns may include synchronization markers, error-checking bits, or other signaling mechanisms depending on the communication protocol being used. Once the switch successfully detects the signals and patterns indicating the completion of link training, it transitions the link to an “up” state. This means that the link is now operational and ready to enter sacrificial mode and operate in sacrificial mode for the sacrificial period.

The method of FIG. 4 includes establishing (816), by the link manager (402), a local sacrificial period (818) in dependence upon the local sacrificial mode parameter (808) and the received sacrificial mode parameter (820) of the link partner. In some embodiments, each sacrificial mode parameter is implemented as a static timeout period and establishing a local sacrificial period is carried out by selecting the longest timeout period. In other embodiments, a sacrificial mode parameter may be multi-dimensional and establishing a sacrificial period may include calculating a period in dependence upon various values, switch configurations and capabilities, and other considerations as will occur to those of skill in the art.

The method of FIG. 4 includes operating (822) one or more ports in sacrificial mode for the sacrificial period (818) including suspending error correction during sacrificial mode. Operating (822) one or more ports in sacrificial mode for the sacrificial period (818) according to the method of FIG. 4 includes determining (823) that link training is over (820) and suspending (824) error correction (824) during the sacrificial period.

Examples of suspending error correction include:
suspending link-level replay;
preventing returning to LNI due to received errors;
preventing a link from going down due to received errors during the sacrificial period;
observing errors without correcting them during the sacrificial period;
and others as will occur to those of skill in the art

Operating (822) one or more ports in sacrificial mode for the sacrificial period (818) according to the method of FIG. 4 determining (825) that the sacrificial period is over (938) and transitioning the operation of one or more ports from sacrificial mode to mission mode. In mission mode, the receive controller (462) no longer has error correction suspended and will engage in replays and other error corrective features as will occur to those of skill in the art.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of sacrificial link operation during link negotiation and initialization, the method comprising;
transmitting, by a link manager of a switch in a high-performance computing system, a local sacrificial mode parameter for one or more ports administered by the local link manager,
receiving, by the link manager, a sacrificial mode parameter for a link partner,
establishing, by the link manager, a local sacrificial period in dependence upon the local sacrificial mode parameter and the received sacrificial mode parameter of the link partner; and
operating one or more ports in sacrificial mode for the sacrificial period including suspending error correction.

2. The method of claim 1 wherein operating one or more ports in sacrificial mode for the sacrificial period includes determining that link training is over and suspending error correction during the sacrificial period.

3. The method of claim 1 wherein operating one or more ports in sacrificial mode for the sacrificial period includes determining that the sacrificial period is over and transitioning the one or more ports from sacrificial mode to mission mode.

4. The method of claim 1 wherein each sacrificial mode parameter comprises a timeout period and establishing a local sacrificial period in dependence upon the local sacrificial mode parameter and the received sacrificial mode parameter of the link partner further comprises selecting the longest timeout period.

5. The method of claim 1 wherein the suspended error correction includes link-level replay.

6. The method of claim 1 wherein suspending error correction includes preventing returning to link negotiation and initialization due to received errors during the sacrificial period.

7. The method of claim 1 wherein suspending error correction includes preventing a link from going down due to received errors during the sacrificial period.

8. The method of claim 1 wherein suspending error correction includes observing errors without correcting them during the sacrificial period.

9. The method of claim 1 further comprising negotiating between link partners to enable sacrificial mode during link negotiation.

10. A switch, the switch comprising:
at least two ports (152);
a switch core (456); and
a control port (420) comprising a management processor (442), wherein the management processor (442) comprises a link manager (458) comprising logic configured to:
establish a sacrificial period in dependence upon a local sacrificial mode parameter and a received sacrificial mode parameter of a link partner; and
operate one or more ports in sacrificial mode for the sacrificial period including suspending error correction.

11. The switch of claim 10 wherein the suspended error correction is link-level replay

12. The switch of claim 10 wherein the link manager administers the operation of a single port.

13. The switch of claim 10 wherein the link manager administers the operation of a plurality of ports.

14. The switch of claim 13 wherein establishing a sacrificial period in dependence upon a local sacrificial mode parameter and a received sacrificial mode parameter of a link partner further comprises establishing a sacrificial period for each port administered by the link manager.

15. The switch of claim 13 wherein establishing a sacrificial period in dependence upon a local sacrificial mode parameter and a received sacrificial mode parameter of a link partner further comprises establishing a single sacrificial period for all ports administered by the link manager.

16. The switch of claim 13 wherein the link manager includes logic configured to enable sacrificial mode after link negotiation.

17. A host fabric adapter, the host fabric adapter comprising:
at least one fabric port comprising a management processor, a serializer/deserializer; a receive controller and a transmit controller;
wherein the management processor comprises a link manager comprising logic configured to:
establish a sacrificial period in dependence upon a local sacrificial mode parameter and a received sacrificial mode parameter of a link partner; and
operate one or more ports in sacrificial mode for the sacrificial period including suspending error correction.

18. The host fabric adapter of claim 17 wherein the suspended error correction is link-level replay.

19. The host fabric adapter of claim 17 suspending error correction includes observing errors without correcting them during the sacrificial period.

20. The host fabric adapter of claim 17 wherein the link manager includes logic configured to enable sacrificial mode after link negotiation.
